(19) United States
(12) Patent Application Publication
(10) Pub. No.: US 2021/0299716 A1
(43) Pub. Date: Sep. 30, 2021

(54) CLEANING APPARATUS, SURFACE TREATMENT APPARATUS, AND CLEANING METHOD

(71) Applicant: MITSUBISHI HEAVY INDUSTRIES, LTD., Tokyo (JP)

(72) Inventors: Takumi SATO, Tokyo (JP); Hiroaki MIKAWA, Tokyo (JP); Hiromitsu NAGAYASU, Tokyo (JP); Kohei KAWASAKI, Tokyo (JP); Taisuke MIYAZAKI, Tokyo (JP); Yuuichi OKUZAKI, Tokyo (JP)

(21) Appl. No.: 17/262,567

(22) PCT Filed: Apr. 15, 2019
(86) PCT No.: PCT/JP2019/016123

§ 371 Date: Jan. 22, 2021

(30) Foreign Application Priority Data
Aug. 3, 2018 (JP) 2018-147032

(51) Int. Cl. B08B 9/093; B08B 3/02; B08B 13/00; C23C 22/82; F26B 21/00

(52) U.S. Cl. CPC B08B 9/093; B08B 3/02; B08B 13/00; B08B 2203/007; F26B 21/004; B08B 2209/08; C23C 22/82

(57) ABSTRACT

A cleaning apparatus 200 is provided with: a treatment tank 10, which defines a treatment space 15 by the inner surfaces (11a, 11b) thereof and on the inner surfaces of which a water-repellent coating has been applied; a cleaning liquid supply device with nozzles 24a (cleaning liquid spray nozzles) for spraying, into the treatment space 15, a mist of a cleaning liquid CL for cleaning surface treatment processing liquid PL adhering to the surface of a metal part S and/or processing liquid PL adhering to the inner surface; and a drying device, which comprises an air compressor 23a and is for supplying drying air compressed by the air compressor 23a to the treatment space 15.

### TECHNICAL FIELD

The present invention relates to a cleaning apparatus, a surface treatment apparatus, and a cleaning method.

### BACKGROUND ART

Conventionally, chromate treatment is known as one type of surface treatment performed on an object to be treated. The chromate treatment is a method of performing surface treatment on a metal part made of, such as iron, zinc, magnesium, and aluminum, with a chromate treatment liquid containing chromic acid as a main component. On the other hand, the use of the chromate treatment liquid is being restricted in consideration of harmful effects of chromium on the environment and the human body. In recent years, non-chromate treatment in which surface treatment is performed on a metal part with a non-chromate treatment liquid containing no chromic acid is under the attention. For example, in PTL 1, a surface treatment apparatus that performs surface treatment on a metal part by spraying a non-chromate treatment liquid in a mist form into a treatment tank where the metal part is disposed and filling the treatment space with mist of the non-chromate treatment liquid is described.

### CITATION LIST

### Patent Literature

[PTL 1] Japanese Unexamined Patent Application Publication No. 2018-59158

### SUMMARY OF INVENTION

### Technical Problem

In non-chromate treatment, for example, the treatment tank is cleaned after the treatment on all metal parts is completed. Examples of a cleaning method for the treatment tank include a method of spraying a cleaning liquid (cleaning water) from a shower head, a method of spraying a cleaning liquid from a rotary or fixed spray nozzle, and a method of blowing wind to a surface to be cleaned through manual work by a worker. In the surface treatment apparatus disclosed in PTL 1, the treatment tank is cleaned by spraying a cleaning liquid from the spray nozzle to the treatment space.

However, in the method using the shower head or the rotary spray nozzle, the used amount of the cleaning liquid increases. An increase in the used amount of the cleaning liquid leads to an increase of a waste liquid. In addition, in the method using the fixed spray nozzle, there is a possibility that the surface to be cleaned cannot be sufficiently cleaned unless a large number of nozzles are provided in various directions in accordance with the shape of the treatment tank. In addition, in the method of blowing wind to the surface to be cleaned through manual work by the worker, the working time becomes long. As described above, the conventional cleaning methods have problems such as an increase in the used amount of the cleaning liquid, an increase of the waste liquid, sufficient cleaning of the surface to be cleaned, and an increase of the working time.

The present invention is devised in view of such problems, and an object thereof is to reduce the used amount and waste liquid amount of a cleaning liquid for cleaning away a treatment liquid, to sufficiently clean a surface to be cleaned, and to shorten working time.

### Solution to Problem

According to an aspect of the present invention, in order to solve the problems described above and achieve the object, there is provided a cleaning apparatus including a treatment tank that defines a treatment space with an inner surface thereof, the inner surface being subjected to water-repellent coating and a cleaning liquid supply device that has a cleaning liquid spraying nozzle spraying, into the treatment space, a cleaning liquid for cleaning away at least one of a treatment liquid for surface treatment, which is adhered to a surface of an object to be treated, and a treatment liquid adhered to the inner surface, in a mist form.

With this configuration, the cleaning liquid can be thoroughly supplied to a surface to be cleaned (the surface of the object to be treated and the inner surface of the treatment tank) with a small amount of cleaning liquid by spraying the cleaning liquid in a mist form to the treatment space and filling the treatment space. Further, since water-repellent coating is performed on the treatment tank, it can be suppressed that the cleaning liquid sprayed in a mist form remains on the inner surface of the treatment tank. As a result, it is not necessary to use an extra cleaning liquid, and the used amount of the cleaning liquid can be further reduced. In addition, the cleaning liquid can be quickly discharged from the treatment tank. Therefore, in the present invention, it is possible to reduce the used amount and waste liquid amount of the cleaning liquid for cleaning away the treatment liquid, to sufficiently clean the surface to be cleaned, and to shorten working time.

In addition, the cleaning apparatus according to the present invention preferably further includes a drying device that has an air compressor and supplies drying air compressed by the air compressor to the treatment space.

With this configuration, after the treatment tank is cleaned with the cleaning liquid, the treatment tank can be quickly dried by the drying device, and it can be suppressed that the cleaning liquid remains in the treatment tank. As a result, it is possible to quickly shift to processing after cleaning, and the working time can be shortened.

In addition, the drying device preferably has a heater that heats the drying air which is compressed by the air compressor and is supplied to the treatment space.

With this configuration, after the treatment tank is cleaned with the cleaning liquid, the treatment tank can be more quickly dried by the drying device.

In addition, the cleaning liquid supply device preferably has a supply line through which the cleaning liquid is supplied to the cleaning liquid spraying nozzle, and the drying device preferably supplies the drying air compressed by the air compressor from the cleaning liquid spraying nozzle to the treatment space via the supply line.

With this configuration, it is possible for the drying device to supply the compressed drying air also to the supply line and the cleaning liquid spraying nozzle, and to suppress that the cleaning liquid remains in the supply line and the cleaning liquid spraying nozzle. In addition, since the supply line and the cleaning liquid spraying nozzle can be shared by the drying device and the cleaning liquid supply device, the apparatus configuration can be simplified.

In addition, the cleaning liquid spraying nozzle is preferably a one-fluid spray nozzle.

With this configuration, facility introduction costs, running costs, and maintenance costs can be reduced compared with a configuration where the cleaning liquid in a mist form is sprayed using an inert gas.

In addition, the cleaning apparatus according to the present invention preferably further includes a humidity measurer that measures humidity inside the treatment tank and humidity outside the treatment tank.

With this configuration, when discharging the cleaning liquid from the treatment tank, whether or not the discharging of the cleaning liquid is completed can be accurately determined by comparing the humidity inside the treatment tank with the humidity outside the treatment tank.

In addition, the cleaning apparatus according to the present invention preferably further includes a collecting line in which the cleaning liquid collected from the treatment space flows and an electric conductivity meter that measures a degree of contamination of the cleaning liquid flowing in the collecting line.

With this configuration, when discharging the cleaning liquid from the treatment tank, a degree of contamination of the cleaning liquid flowing in the collecting line is measured by the electric conductivity meter, and whether or not cleaning is completed can be accurately determined by comparing the measured degree of contamination with a predetermined reference value.

In addition, the cleaning apparatus according to the present invention preferably further includes a suppression device that suppresses leakage of the cleaning liquid from an opening provided in an upper portion of the treatment tank.

With this configuration, the loss of the cleaning liquid can be suppressed.

In addition, the suppression device is preferably an air curtain device that seals the opening with an air flow.

With this configuration, the suppression device having a lighter weight and a simpler configuration can be configured compared with a case where a mechanism that opens and closes the opening of the treatment tank is provided. In addition, the suppression device can be easily configured only by attaching the air curtain device to the existing treatment tank.

In addition, the cleaning apparatus according to the present invention preferably further includes a temperature adjusting device that adjusts a temperature of the cleaning liquid supplied to the cleaning liquid spraying nozzle.

With this configuration, the temperature of the cleaning liquid can be finely adjusted and a non-chromate treatment liquid from the treatment tank can be cleaned away more adequately.

In addition, the cleaning apparatus according to the present invention preferably further includes a mist concentration measurer that measures a mist concentration inside the treatment space.

With this configuration, the mist concentration of the cleaning liquid with which the treatment space is filled can be managed and appropriately adjusted.

In addition, an average droplet diameter of mist of the cleaning liquid is preferably 70 [μm] or less.

With this configuration, the average droplet diameter of the mist can be made sufficiently small, and the mist can slowly drift in the treatment space. As a result, it is possible to sufficiently supply the cleaning liquid to the surface to be cleaned.

In addition, a mist concentration of the cleaning liquid in the treatment space is preferably 100 [mL] or more and 5,000 [mL] or less per 1 [m³] of the treatment space.

With this configuration, the cleaning liquid can be sufficiently supplied to the surface to be cleaned while suppressing an increase in the used amount of the cleaning liquid supplied to the treatment space.

In addition, an amount of the cleaning liquid supplied from the cleaning liquid spraying nozzle to the treatment space is preferably 1.5 [L/min] or less per 1 [m³] of the treatment space.

With this configuration, the cleaning liquid can be sufficiently supplied to the surface to be cleaned while suppressing an increase in the used amount of the cleaning liquid supplied to the treatment space.

According to another aspect of the present invention, in order to solve the problems described above and achieve the object, there is provided a surface treatment apparatus including the cleaning apparatus and a treatment liquid supply device that supplies a treatment liquid for performing surface treatment on an object to be treated disposed in the treatment space of the treatment tank.

With this configuration, in the surface treatment apparatus including the treatment liquid supply device and the cleaning apparatus, it is possible to reduce the used amount and waste liquid amount of the cleaning liquid for cleaning away the treatment liquid, to sufficiently clean the surface to be cleaned, and to shorten working time. In addition, since the treatment liquid is supplied to the object to be treated in the treatment space of the treatment tank whose inner surface is subjected to water-repellent coating, it can be suppressed that the treatment liquid remains on the inner surface of the treatment tank. As a result, it is not necessary to use an extra treatment liquid, and the used amount of the treatment liquid can be further reduced. In addition, the treatment liquid can be quickly discharged from the treatment tank.

According to still another aspect of the present invention, in order to solve the problems described above and achieve the object, there is provided a cleaning method including a cleaning processing step of spraying, to a treatment space of a treatment tank that defines the treatment space with an inner surface thereof, the inner surface being subjected to water-repellent coating, a cleaning liquid for cleaning away at least one of a treatment liquid for surface treatment, which is adhered to a surface of an object to be treated, and a treatment liquid, which is adhered to the inner surface, in a mist form.

With this configuration, the cleaning liquid can be thoroughly supplied to the surface to be cleaned with a small amount of cleaning liquid by spraying the cleaning liquid in a mist form to the treatment space and filling the treatment space. Further, since water-repellent coating is performed on the treatment tank, it can be suppressed that the cleaning liquid sprayed in a mist form remains on the surface to be cleaned of the treatment tank. As a result, it is not necessary to use an extra cleaning liquid, and the used amount of the cleaning liquid can be further reduced. Therefore, in the present invention, it is possible to reduce the used amount and waste liquid amount of the cleaning liquid for cleaning away the treatment liquid, to sufficiently clean the surface to be cleaned, and to shorten working time.

In addition, the cleaning method according to the present invention preferably further includes a drying processing step of supplying drying air compressed by an air compressor to the treatment space after the cleaning processing step.

With this configuration, after the treatment tank is cleaned with the cleaning liquid, the treatment tank can be quickly dried in the drying processing step, and it can be suppressed that the cleaning liquid remains in the treatment tank. As a result, it is possible to quickly shift to processing after cleaning, and the working time can be shortened.

### BRIEF DESCRIPTION OF DRAWINGS

FIG. 1 is an explanatory diagram schematically showing an example of a surface treatment apparatus according to an embodiment.

FIG. 2 is an explanatory diagram schematically showing a treatment tank.

FIG. 3 is a flowchart showing an example of processing by the surface treatment apparatus according to the embodiment.

FIG. 4 is an explanatory graph showing a relationship between a cleaning time and a mist concentration in a treatment space in a case where pump flow rate is changed in the surface treatment apparatus according to the present embodiment.

FIG. 5 is an explanatory graph showing a relationship between a cleaning time and a degree of contamination in a case where pump flow rate is changed in the surface treatment apparatus according to the present embodiment.

### DESCRIPTION OF EMBODIMENTS

Hereinafter, an embodiment of a cleaning apparatus, a surface treatment apparatus, and a cleaning method according to the present invention will be described in detail based on the drawings. The invention is not limited to this embodiment.

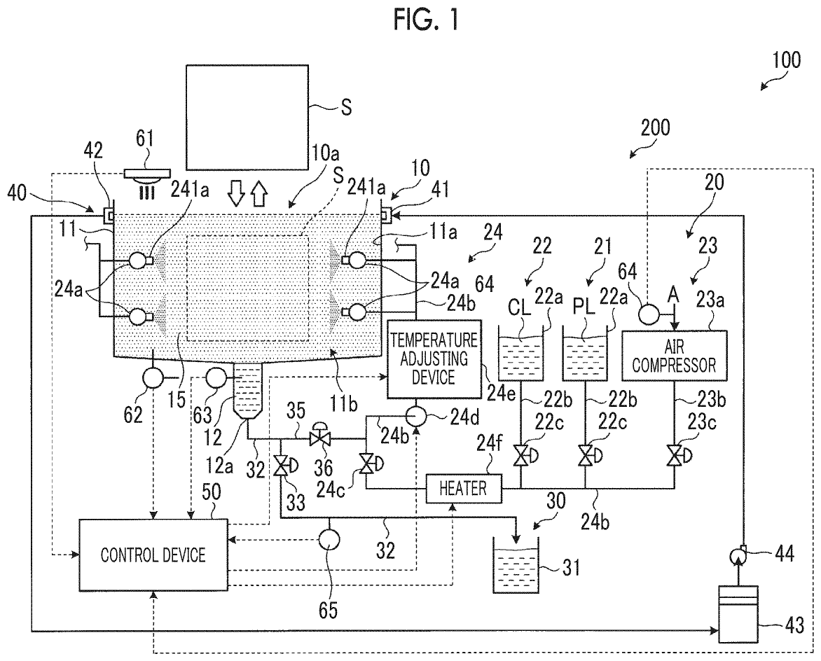

FIG. 1 is an explanatory diagram schematically showing an example of the surface treatment apparatus according to the embodiment. A surface treatment apparatus 100 is an apparatus that performs non-chromate treatment on a metal part S, which is an object to be treated, using a non-chromate treatment liquid PL. In the present embodiment, an example in which the surface treatment apparatus 100 is configured to include a cleaning apparatus 200 that supplies a cleaning liquid CL for cleaning away the non-chromate treatment liquid PL will be described. For example, cleaning water can be used as the cleaning liquid CL, but the cleaning liquid is not limited thereto insofar as the non-chromate treatment liquid PL, which is adhered to a surface to be cleaned, can be cleaned away.

Non-chromate treatment is chemical conversion treatment of imparting a property different from a material for the metal part S to a surface of the metal part S by causing a chemical reaction with the non-chromate treatment liquid PL containing no chromium on the surface of the metal part S. The metal part S on which non-chromate treatment is performed is used, for example, in a structure such as an aircraft.

The metal part S is a member having a surface made of a metal such as iron, zinc, magnesium, aluminum, stainless steel, and titanium. The metal part S may be made of at least one of cold rolled steel, hot rolled steel, stainless steel, electrogalvanized steel, hot dip galvanized steel, zinc-aluminum alloy-based plated steel, zinc-iron alloy-based plated steel, zinc-magnesium alloy-based plated steel, zinc-aluminum-magnesium alloy-based plated steel, aluminum-based plated steel, aluminum-silicon alloy-based plated steel, tin-based plated steel, lead-tin alloy-based plated steel, chrome-based plated steel, and nickel-based plated steel.

The non-chromate treatment liquid PL is generated by mixing a plurality of types of chemical liquids and has a pot life. In the present embodiment, the non-chromate treatment liquid PL is a treatment liquid containing a silane compound as a main component. The non-chromate treatment liquid PL contains a silane coupling agent, and forms an organic film on the metal part S. The non-chromate treatment liquid PL may contain, for example, two or more types of silane coupling agents, may contain a silane coupling agent, water-dispersible silica, and zirconium or titanium ions, may contain a silane coupling agent having a specific functional group that reacts with an aqueous emulsion, or may contain a compound, in which an aqueous emulsion, a trivalent transition metal ion, two β-diketone molecules and two water molecules are coordinated, and a silane coupling agent.

When brought into contact with water, a silane coupling agent is hydrolyzed to generate a silanol group. The silanol group is polymerized by self-condensation, is chemically bonded to the OH group on a metal surface due to an acid-base reaction, and is stabilized as a coating base. In addition, the silanol group chemically bonds or cross-links with a paint component to be firmly bonded with each other, thereby achieving good adhesion.

In a case where the non-chromate treatment liquid PL is produced by mixing a plurality of types of chemical liquids, a silane coupling agent gradually polymerizes with the elapse of time after mixing the plurality of types of chemical liquids. When the non-chromate treatment liquid PL becomes a polymer, it is difficult to adequately apply the non-chromate treatment liquid to the surface of the metal part S. For this reason, a usable time is set for the non-chromate treatment liquid PL, which is referred to as a pot life. In the present embodiment, the surface treatment apparatus 100 applies the non-chromate treatment liquid PL before the pot life has ended to the surface of the metal part S. In the surface treatment apparatus 100, in a case where the non-chromate treatment liquid has reached the pot life, it is necessary to replace the non-chromate treatment liquid PL, and in this case, cleaning is performed prior to the replacement.

The surface treatment apparatus 100 will be described in detail with reference to the drawings. As shown in FIG. 1, the surface treatment apparatus 100 includes a treatment tank 10, a supply unit 20, a collecting unit 30, a suppression device 40, and a control device 50. In the following description, the non-chromate treatment liquid PL will be simply referred to as “treatment liquid PL”.

[Treatment Tank]

In the treatment tank 10, the metal part S is disposed, and a treatment space 15 for performing non-chromate treatment on the metal part S is formed. The metal part S is carried in and out of the treatment space 15 via an opening 10a by a carrying device (not shown). In the present embodiment, a plurality of metal parts S are disposed in the treatment space 15.

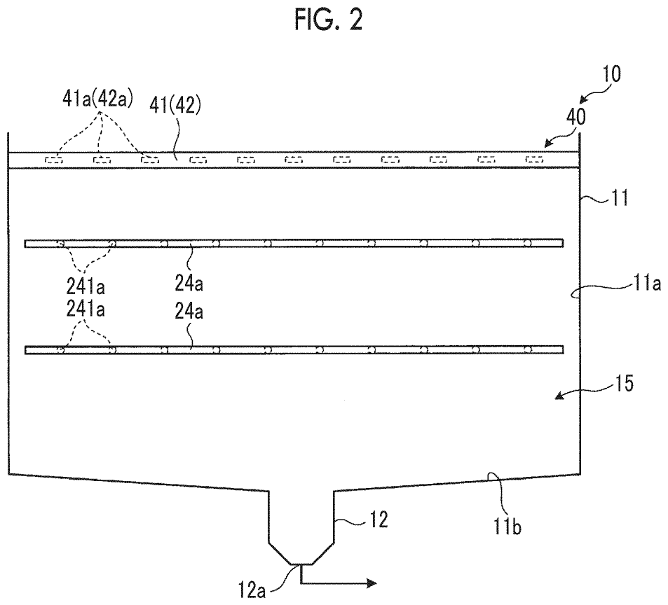

FIG. 2 is an explanatory diagram schematically showing the treatment tank. The treatment tank 10 has a main body portion 11 and a collection portion 12. The main body portion 11 has an inner side surface 11a and a bottom surface 11b, which are inner surfaces defining the treatment space 15. The opening 10a described above is formed in an upper portion of the main body portion 11. The collection portion 12 is provided in the bottom surface 11b of the main body portion 11, and communicates with the treatment space 15. The collection portion 12 collects the treatment liquid PL and the cleaning liquid CL that have settled from the treatment space 15, and the treatment liquid PL and the cleaning liquid CL that are sent from the inner side surface 11a and the bottom surface 11b. The treatment liquid PL and the cleaning liquid CL that are collected by the collection portion 12 are discharged from a discharge port 12a to the outside of the tank.

In the present embodiment, the bottom surface 11b of the main body portion 11 is inclined downward as going toward the collection portion 12. In addition, a bottom surface of the collection portion 12 is inclined downward as going toward the discharge port 12a. Accordingly, it can be suppressed that the treatment liquid PL and the cleaning liquid CL stays on the bottom surface 11b of the main body portion 11 and the bottom surface of the collection portion 12, and the treatment liquid PL and the cleaning liquid CL can be quickly collected and discharged.

In addition, in the present embodiment, water-repellent coating is performed on at least the inner side surface 11a and the bottom surface 11b of the main body portion 11 of the treatment tank 10. As water-repellent coating, for example, a fluororesin coating can be used. Water-repellent coating is performed preferably using a coating agent that adequately repels at least the cleaning liquid CL (warm water in the present embodiment), and more preferably performed using a coating agent that repels the treatment liquid PL.

[Supply Device]

Description will return to FIG. 1. In the present embodiment, the supply unit 20 configures a treatment liquid supply device that supplies the treatment liquid PL to the treatment space 15, a cleaning liquid supply device that supplies the cleaning liquid CL, and a drying device that supplies drying air A. The supply unit 20 has a treatment liquid supply system 21, a cleaning liquid supply system 22, an air supply system 23, and a common supply system 24. A configuration of the surface treatment apparatus 100 excluding the treatment liquid supply system 21 corresponds to the cleaning apparatus 200 according to the embodiment.

The treatment liquid supply system 21 has a treatment liquid storage portion 21a, a treatment liquid supply line 21b, and a treatment liquid supply valve 21c. The treatment liquid storage portion 21a is a tank that stores the treatment liquid PL. The treatment liquid supply line 21b is a pipe connected to the treatment liquid storage portion 21a, and the treatment liquid PL from the treatment liquid storage portion 21a flows therein. The treatment liquid supply valve 21c is an opening-closing valve that is provided in the treatment liquid supply line 21b and switches between supply and stop of supply of the treatment liquid PL from the treatment liquid storage portion 21a. The treatment liquid supply valve 21c is controlled by the control device 50.

The cleaning liquid supply system 22 has a cleaning liquid storage portion 22a, a cleaning liquid supply line 22b, and a cleaning liquid supply valve 22c. The cleaning liquid storage portion 22a is a tank that stores the cleaning liquid CL. The cleaning liquid supply line 22b is a pipe connected to the cleaning liquid storage portion 22a, and the cleaning liquid CL from the cleaning liquid storage portion 22a flows therein. The cleaning liquid supply valve 22c is an opening-closing valve that is provided in the cleaning liquid supply line 22b and switches between supply and stop of supply of the cleaning liquid CL from the cleaning liquid storage portion 22a. The cleaning liquid supply valve 22c is controlled by the control device 50.

The air supply system 23 has an air compressor 23a, an air supply line 23b, and an air supply valve 23c. The air compressor 23a is a compressor that compresses and sends out the drying air A from an air supply source (not shown) (for example, an atmospheric space). The drying air A may be air or may be other gas. The air supply line 23b is a pipe connected to the air compressor 23a, and the drying air A compressed by the air compressor 23a flows therein. The air supply valve 23c is an opening-closing valve that is provided in the air supply line 23b and switches between supply and stop of supply of the drying air A from the air compressor 23a. The air compressor 23a and the air supply valve 23c are controlled by the control device 50.

The common supply system 24 has a plurality of nozzle portions 24a, a common supply line 24b, a common supply valve 24c, a pump 24d, a temperature adjusting device 24e, and a heater 24f.

The plurality of nozzle portions 24a are disposed in the treatment tank 10. As shown in FIG. 1, the nozzle portions 24a are respectively disposed on both side portions of the treatment tank 10 in two rows in a height direction. The nozzle portions 24a on both side portions are disposed to face each other as shown in FIG. 1. As shown in FIG. 2, each nozzle portion 24a extends along a side wall of the treatment tank 10. Each nozzle portion 24a has a plurality of spray ports 241a formed at intervals from each other along a longitudinal direction. The number of nozzle portions 24a, a disposition configuration, and the orientations of the spray ports 241a are examples, and may be any number, disposition configuration, and orientation insofar as the treatment liquid PL and the cleaning liquid CL can be sufficiently supplied. For example, the nozzle portions 24a may be disposed in a zigzag pattern in the height direction.

Each nozzle portion 24a is configured as a one-fluid spray nozzle that sprays, in a mist form, the treatment liquid PL from the treatment liquid supply system 21 and the cleaning liquid CL from the cleaning liquid supply system 22 described above from the plurality of spray ports 241a. That is, each nozzle portion 24a sprays the treatment liquid PL or the cleaning liquid CL whose pressure is increased by the pump 24d from the spray ports 241a without mixing the treatment liquid PL or the cleaning liquid CL with compressed air, thereby making the atmosphere of the treatment space 15 filled with the mist of the treatment liquid PL or the cleaning liquid CL. In addition, each nozzle portion 24a sprays the drying air A from the air supply system 23 described above toward the treatment space 15.

The common supply line 24b is connected to each nozzle portion 24a, and is connected to the treatment liquid supply line 21b, the cleaning liquid supply line 22b, and the air supply line 23b. Inside the common supply line 24b, the treatment liquid PL from the treatment liquid supply line 21b, the cleaning liquid CL from the cleaning liquid supply line 22b, and the drying air A from the air supply line 23b are supplied, depending on the treatment content. The common supply valve 24c is an opening-closing valve that is provided in the common supply line 24b and switches between supply and stop of supply of the treatment liquid PL, the cleaning liquid CL or the drying air A. The pump 24d is provided in the common supply line 24b on each nozzle portion 24a side from the treatment liquid supply valve 21c, and pumps the treatment liquid PL or the cleaning liquid CL flowing in the common supply line 24b to each nozzle portion 24a. The treatment liquid supply valve 21c and the pump 24d are controlled by the control device 50.

The temperature adjusting device 24e is provided in the common supply line 24b on each nozzle portion 24a side from the pump 24d. The temperature adjusting device 24e heats or cools the treatment liquid PL and the cleaning liquid CL that are pumped by the pump 24d, and adjusts the temperatures thereof to appropriate temperatures. The heater 24f is provided in the common supply line 24b at least on each nozzle portion 24a side from a connecting portion with the air supply line 23b. The heater 24f heats the drying air A flowing in the common supply line 24b to increase the temperature thereof. The heater 24f may heat the treatment liquid PL and the cleaning liquid CL that flow in the common supply line 24b to increase the temperatures thereof. The temperature adjusting device 24e and the heater 24f are controlled by the control device 50.

Accordingly, the treatment liquid supply system 21, the common supply system 24, and a circulation system to be described later configure a treatment liquid supply device that supplies the treatment liquid PL to the treatment space 15. In addition, the cleaning liquid supply system 22 and the common supply system 24 configure a cleaning liquid supply device that supplies the cleaning liquid CL to the treatment space 15. For this reason, in the present embodiment, the nozzle portions 24a are cleaning liquid spraying nozzles. In addition, the air supply system 23 and the common supply system 24 configure a drying device that supplies the drying air A to the treatment space 15.

[Collecting Unit]

The collecting unit 30 collects the treatment liquid PL that has reached a pot life and the cleaning liquid CL that has been used for cleaning. The collecting unit 30 has a waste liquid pit 31, a collecting line 32, and a collecting valve 33. The waste liquid pit 31 temporarily stores the treatment liquid PL and the cleaning liquid CL that are collected from the collection portion 12 of the treatment tank 10. The collecting line 32 is a pipe connected to the collection portion 12 of the treatment tank 10 and the waste liquid pit 31, and the treatment liquid PL and the cleaning liquid CL that are collected from the treatment tank 10 flow therein. The collecting valve 33 is an opening-closing valve that is provided in the collecting line 32 and switches between collection and stop of collection of the treatment liquid PL and the cleaning liquid CL from the treatment tank 10. The collecting valve 33 is controlled by the control device 50. The waste liquid pit 31 may be provided separately from pits for collecting the treatment liquid PL and the cleaning liquid CL.

In addition, in the present embodiment, the surface treatment apparatus 100 has a circulation system for circulating and using the treatment liquid PL that has not reached the pot life. More specifically, the surface treatment apparatus 100 has a circulation line 35 and a circulation valve 36 as a circulation system. The circulation line 35 branches from the collecting line 32 on a treatment tank 10 side from the collecting valve 33. In addition, the circulation line 35 is connected to the common supply line 24b between the common supply valve 24c and the pump 24d. The circulation valve 36 is an opening-closing valve that is provided in the circulation line 35 and switches between circulation and stop of circulation of the treatment liquid PL from the treatment tank 10. The circulation valve 36 is controlled by the control device 50.

Accordingly, in the surface treatment apparatus 100, in a state where the circulation valve 36 is opened and the common supply valve 24c and the collecting valve 33 are closed, the pump 24d is driven. Consequently, the treatment liquid PL collected from the treatment tank 10 can be supplied to each nozzle portion 24a again via the circulation line 35 and the common supply line 24b. That is, the treatment liquid PL that has not reached the pot life can be circulated and used.

[Suppression Device]

The suppression device 40 is a device that suppresses leakage of the non-chromate treatment liquid PL and the cleaning liquid CL from the opening 10a provided in the upper portion of the treatment tank 10. In the present embodiment, the suppression device 40 is an air curtain device. The suppression device 40 has an air jetting unit 41, an air suction unit 42, a mist collector 43, and a blower 44.

The air jetting unit 41 and the air suction unit 42 are disposed to face each other below the opening 10a. The air jetting unit 41 and the air suction unit 42 extend along the side wall of the treatment tank 10. As shown in FIG. 2, the air jetting unit 41 has a plurality of jetting ports 41a formed at intervals from each other along the longitudinal direction. In addition, the air suction unit 42 has a plurality of suction ports 42a formed at intervals from each other along the longitudinal direction (refer to FIG. 1). The suppression device 40 jets air, which is sent from the blower 44, from the plurality of jetting ports 41a of the air jetting unit 41, and forms an air flow that seals the opening 10a as the plurality of suction ports 42a of the air suction unit 42 suck the air. The air used in the air curtain device may be air or other gas.

The mist collector 43 is connected to the air suction unit 42, and collects the treatment liquid PL and the cleaning liquid CL that are sucked together with the air by the air suction unit 42. The mist collector 43 has a gas-liquid separation function, and the air separated into a gas and a liquid by the mist collector 43 is sent to the air jetting unit 41 again by the blower 44. A temperature adjuster that adjusts the temperatures of the treatment liquid PL and the cleaning liquid CL that are sucked from the air suction unit 42 may be provided on an upstream side of the mist collector 43. The treatment liquid PL collected in the mist collector 43 is sent to the circulation system or the waste liquid pit 31 described above via a pipe (not shown). In addition, the cleaning liquid CL collected in the mist collector 43 is sent to the waste liquid pit 31.

[Various Types of Sensors]

In addition, the surface treatment apparatus 100 (and the cleaning apparatus 200) has a plurality of sensors for managing a processing state when executing various types of processing. More specifically, the surface treatment apparatus 100 (and the cleaning apparatus 200) has a mist concentration measurer 61, a humidity measurer 62, temperature measurers 63 and 64, and an electric conductivity meter 65.

The mist concentration measurer 61 is provided above the treatment tank 10. The mist concentration measurer 61 measures the mist concentrations of the treatment liquid PL and the cleaning liquid CL in the treatment space 15. As the mist concentration measurer 61, for example, an absorptiometer can be used. The humidity measurer 62 is a hygrometer that can measure humidity inside and humidity outside the treatment tank 10. The temperature measurer 63 measures the temperature of the treatment liquid PL in the collection portion 12 of the treatment tank 10. The temperature measurer 64 measures the temperature of the drying air A supplied to the air compressor 23a. The temperature measurer 64 may be provided in the air supply line 23b or the common supply line 24b. The electric conductivity meter 65 is provided in the collecting line 32 on a waste liquid pit 31 side from the collecting valve 33. The electric conductivity meter 65 measures the electric conductivity of the cleaning liquid CL flowing in the collecting line 32. The electric conductivity of the cleaning liquid CL is a value that serves as an index of a degree of contamination. That is, the electric conductivity meter 65 measures a degree of contamination of the cleaning liquid CL flowing in the collecting line 32. The mist concentration measurer 61, the humidity measurer 62, the temperature measurers 63 and 64, and the electric conductivity meter 65 output measurement results to the control device 50.

[Control Device]

Signals from the mist concentration measurer 61, the humidity measurer 62, the temperature measurers 63 and 64, and the electric conductivity meter 65 are input into the control device 50. In addition, the control device 50 controls configuring elements including each valve, the pump 24d, the temperature adjusting device 24e, the heater 24f, and the suppression device 40 that are included in the surface treatment apparatus 100 with reference to input detection signals, and executes various types of processing by the surface treatment apparatus 100. Hereinafter, the content of each type of processing by the control device 50 will be described. In the following description, the treatment liquid supply valve 21c, the cleaning liquid supply valve 22c, the air supply valve 23c, the common supply valve 24c, the collecting valve 33, and the circulation valve 36 are in a closed state unless stated otherwise.

When the metal part S is disposed in the treatment space 15, the control device 50 executes non-chromate treatment of supplying mist of the treatment liquid PL from the plurality of nozzle portions 24a to the treatment space 15 and adhering the treatment liquid PL to the surface of the metal part S. More specifically, the control device 50 drives the suppression device 40 to seal the opening 10a of the treatment tank 10. In a case of supplying the new treatment liquid PL to the treatment space 15, the control device 50 brings the treatment liquid supply valve 21c and the common supply valve 24c into an open state. Then, the control device 50 drives the pump 24d to increase the pressure of the treatment liquid PL stored in the treatment liquid storage portion 21a and to pump the treatment liquid to each nozzle portion 24a via the treatment liquid supply line 21b and the common supply line 24b. Accordingly, the mist of the treatment liquid PL is supplied from each nozzle portion 24a to the treatment space 15, and the treatment space 15 is filled with the mist of the treatment liquid PL. Consequently, the treatment liquid PL adheres to the surface of the metal part S. As a result, it is possible to thoroughly perform non-chromate treatment on the surface of the metal part S using a small amount of the treatment liquid PL.

In addition, in a case where the treatment liquid PL has not reached the pot life in non-chromate treatment, the control device 50 circulates and uses the treatment liquid PL. Whether or not the treatment liquid PL has reached the pot life can be determined based on, for example, the time of use of the treatment liquid PL. In a case of circulating the treatment liquid PL, the control device 50 brings the circulation valve 36 into an open state. Accordingly, the treatment liquid PL collected in the collection portion 12 of the treatment tank 10 can be again supplied to each nozzle portion 24a via the collecting line 32, the circulation line 35, and the common supply line 24b. In non-chromate treatment, the control device 50 controls each nozzle portion 24a and the pump 24d such that the mist concentration of the treatment space 15 measured by the mist concentration measurer 61 is constant. In addition, the control device 50 controls the temperature adjusting device 24e based on the temperature of the treatment liquid PL in the collection portion 12, which is measured by the temperature measurer 63, and adjusts the mist of the treatment liquid PL to have an appropriate temperature.

In addition, the control device 50 executes cleaning processing for the surface treatment apparatus 100 under a predetermined condition. Examples of the predetermined condition include a time when non-chromate treatment on the metal part S by the surface treatment apparatus 100 is ended or a time when replacing the treatment liquid PL which has reached the pot life with the new treatment liquid PL. Cleaning processing may be executed in any case of a state where the metal part S is not disposed in the treatment space 15 and a state where the metal part is disposed in the treatment space.

During cleaning processing, the control device 50 stops driving the pump 24d, and stops supplying the mist of the treatment liquid PL. In addition, the control device brings the collecting valve 33 into an open state. Accordingly, the treatment liquid PL in the treatment space 15 settles, flows to the collection portion 12 along the inner side surface 11a and the bottom surface 11b of the treatment tank 10, and is collected in the waste liquid pit 31 via the collecting line 32.

Then, the control device 50 brings the cleaning liquid supply valve 22c, the common supply valve 24c, and the collecting valve 33 into an open state. In addition, the control device 50 drives the suppression device 40 to seal the opening 10a of the treatment tank 10. The control device 50 again drives the pump 24d to increase the pressure of the cleaning liquid CL stored in the cleaning liquid storage portion 22a and to pump the cleaning liquid to each nozzle portion 24a via the cleaning liquid supply line 22b and the common supply line 24b. Accordingly, the mist of the cleaning liquid CL is supplied from each nozzle portion 24a to the treatment space 15, and the mist of the cleaning liquid CL fills the treatment space 15. In cleaning processing, the control device 50 controls each nozzle portion 24a and the pump 24d such that the mist concentration of the treatment space 15 measured by the mist concentration measurer 61 is constant. As a result, it is possible to clean the inner side surface 11a and the bottom surface 11b of the treatment tank 10 using a small amount of the cleaning liquid CL as the cleaning liquid CL thoroughly adheres thereto. The control device 50 determines whether or not the cleaning is completed based on the value of a degree of contamination input from the electric conductivity meter 65. That is, by comparing the value of the degree of contamination input from the electric conductivity meter 65 with a predetermined reference value, it can be determined that the cleaning is completed. Similar to non-chromate treatment, the temperature of the mist of the cleaning liquid CL may be adjusted by controlling the temperature adjusting device 24e based on the temperature of the cleaning liquid CL in the collection portion 12, which is measured by the temperature measurer 63. In addition, similar to non-chromate treatment, the cleaning liquid CL may be circulated and used for a certain period of time by bringing the circulation valve 36 into an open state.

Further, the control device 50 executes drying processing. The control device 50 stops driving the pump 24d and brings the cleaning liquid supply valve 22c into a closed state. The control device 50 brings the air supply valve 23c into an open state and drives the air compressor 23a. Accordingly, the drying air A compressed by the air compressor 23a is supplied to each nozzle portion 24a via the air supply line 23b and the common supply line 24b, and is supplied from each nozzle portion 24a to the treatment space 15. In addition, the control device 50 controls the heater 24f based on the temperature of the drying air A detected by the temperature measurer 64 to heat the drying air A flowing in the common supply line 24b. As a result, the treatment tank 10 can be dried with the drying air A and thus it can be suppressed that the cleaning liquid CL remains in the treatment tank 10. Further, by spraying the drying air A from each nozzle portion 24a via the common supply line 24b, the remaining of the cleaning liquid CL not only in the treatment tank 10 but also in the common supply line 24b and each nozzle portion 24a can be suppressed.

At this time, the control device 50 determines whether or not the cleaning liquid CL remains in the treatment tank based on a difference between humidity inside the treatment tank 10 and humidity outside the treatment tank 10, which are input from the humidity measurer 62. In a case where the cleaning liquid CL remains in the treatment tank 10, the cleaning liquid CL remaining in the treatment tank 10 is vaporized, and thereby the humidity inside the treatment tank 10 becomes higher than the humidity outside the treatment tank. For this reason, in a case where the difference between the humidity inside the treatment tank and the humidity outside the treatment tank is sufficiently small, it can be determined that the cleaning liquid CL has been sufficiently removed from the treatment tank 10.

By executing cleaning processing and drying processing in this manner, the treatment liquid PL from the treatment tank 10, the common supply line 24b, and each nozzle portion 24a can be cleaned, and the cleaning liquid CL used in cleaning can be quickly discharged. As a result, for example, it is possible to quickly shift to the execution of non-chromate treatment using the new treatment liquid PL.

[Cleaning Conditions]

Conditions for cleaning processing described above will be described. The conditions for cleaning processing are not limited to those exemplified herein.

In the present embodiment, an average droplet diameter of the mist of the cleaning liquid CL supplied from each nozzle portion 24a to the treatment space 15 is preferably 70 [μm] or less. The average droplet diameter of the mist is more preferably 20 [μm] or more and 40 [μm] or less.

In addition, the control device 50 adjusts the amount of the cleaning liquid CL supplied from each nozzle portion 24a to the treatment space 15 per unit time based on the size (volume) of the treatment space 15. In the present embodiment, the amount of the cleaning liquid CL supplied from each nozzle portion 24a to the treatment space 15 is preferably 100 [mL] or more and 5,000 [mL] or less per 1 [m³] of the treatment space 15.

Each nozzle portion 24a sprays the cleaning liquid CL such that the mist concentration of the cleaning liquid CL in the treatment space 15 is sufficiently high and uniform. The mist concentration refers to the amount (proportion) of the mist of the cleaning liquid CL existing per unit volume of the treatment space 15. The control device 50 adjusts the flow rate of the mist of the cleaning liquid CL sprayed from the spray ports 241a of each nozzle portion 24a such that the mist concentration in the treatment space 15 becomes uniform. The mist concentration of the cleaning liquid CL in the treatment space 15 is preferably high such that the cleaning liquid CL is sufficiently applied to the surface to be cleaned (inner surface) of the treatment tank 10. In the present embodiment, the mist concentration of the cleaning liquid CL in the treatment space 15 is preferably 1.0 [L] or more and 1.50 [L] or less per 1 [m³] of the treatment space 15.

The treatment space 15 is filled with the mist of the cleaning liquid CL supplied from each nozzle portion 24a. The average droplet diameter of the mist is sufficiently small, and the mist drifts slowly in the treatment space 15. The mist drifting in the treatment space 15 adheres not only to the surface of the treatment tank 10 facing each nozzle portion 24a but also to the surface of the treatment tank 10 not facing each nozzle portion 24a. That is, since the mist sprayed from each nozzle portion 24a diffuses throughout the treatment tank 10, the mist also adheres to the surface of the treatment tank 10 that does not face each nozzle portion 24a. In addition, the mist evenly adheres to the surface of the treatment tank 10 without being limited to the shape of the treatment tank 10. In addition, in a case where the plurality of metal part S are disposed in the treatment space 15, the mist evenly adheres to the surface of each of the plurality of metal parts S. Accordingly, the metal parts S can be cleaned.

[Operation by Surface Treatment Apparatus]

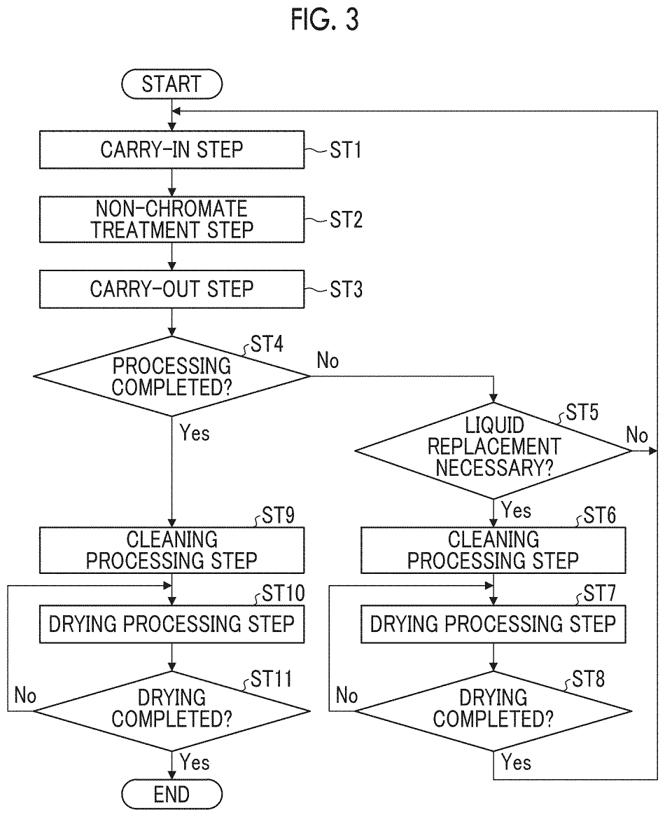

Next, an example of an operation by the surface treatment apparatus including a cleaning method according to the embodiment will be described with reference to FIG. 3. FIG. 3 is a flowchart showing an example of processing by the surface treatment apparatus according to the embodiment. The processing shown in FIG. 3 is executed by the control device 50.

As Step ST1, the control device 50 executes a carry-in step of carrying the metal part S into the treatment space 15. In the carry-in step, the metal part S is carried into a predetermined position in the treatment space 15 using a carry-in/out mechanism (not shown).

Next, as Step ST2, the control device 50 executes a non-chromate treatment step of supplying the mist of the treatment liquid PL from the plurality of nozzle portions 24a to the treatment space 15 and adhering the treatment liquid PL to the surface of the metal part S. In the non-chromate treatment step, as described above, first, the suppression device 40 is driven to seal the opening 10a of the treatment tank 10. Then, the treatment liquid supply valve 21c and the common supply valve 24c are brought into an open state and the pump 24d is driven. Accordingly, the new treatment liquid PL from the treatment liquid storage portion 21a is sprayed in a mist form from the nozzle portions 24a. After then, the pump 24d is temporarily stopped being driven, the treatment liquid supply valve 21c and the common supply valve 24c are brought into a closed state, the circulation valve 36 is brought into an open state, and the pump 24d is driven again to circulate and use the treatment liquid PL. Non-chromate treatment is executed only for a time sufficient for the treatment liquid PL to adhere to the metal part S.

As Step ST3, the control device 50 executes a carry-out step of carrying the metal part S, on which non-chromate treatment is performed, out from the treatment tank 10. In the carry-out step, the pump 24d is stopped being driven. After the treatment liquid PL in the treatment space 15 has settled, the driving of the suppression device 40 is stopped. Then, the metal part S is carried out from the predetermined position in the treatment space 15 using the carry-in/out mechanism (not shown).

As Step ST4, the control device 50 determines whether or not non-chromate treatment on all the metal parts S is completed. In a case where it is determined that non-chromate treatment on all the metal parts S is completed, the control device 50 proceeds to Step ST5.

As Step ST5, the control device 50 determines whether or not replacement of the treatment liquid PL is necessary. In a case where the time of use of the circulating treatment liquid PL does not exceed a predetermined time, the control device 50 determines that the liquid replacement is not necessary, again executes the processing of Step ST1 and thereafter, and executes non-chromate treatment on the new metal part S. On the other hand, in a case where the time of use of the circulating treatment liquid PL exceeds the predetermined time, the control device 50 determines that the treatment liquid PL has reached a pot life and requires liquid replacement, and proceeds to processing of Step ST6 to Step S8, which corresponds to the cleaning method according to the embodiment.

As Step ST6, the control device 50 executes a cleaning processing step. As described above, the control device 50 temporarily stops the driving of the pump 24d, brings the collecting valve 33 into an open state, and brings the cleaning liquid supply valve 22c, the common supply valve 24c, and the collecting valve 33 into an open state. In addition, the control device 50 drives the suppression device 40. Then, the control device 50 drives the pump 24d again to spray the cleaning liquid CL in a mist form from each nozzle portion 24a. At this time, the control device 50 causes the mist of the cleaning liquid CL to be sprayed from each nozzle portion 24a in accordance with the cleaning conditions described above. Accordingly, it is possible to clean the inner side surface 11a and the bottom surface 11b of the treatment tank 10 using a small amount of the cleaning liquid CL as the cleaning liquid CL thoroughly adheres thereto. The control device 50 compares the value of a degree of contamination of the cleaning liquid CL flowing in the collecting line 32, which is measured by the electric conductivity meter 65, with a predetermined reference value. In a case where the treatment tank 10 is sufficiently cleaned, the control device determines that the cleaning is completed and proceeds to Step ST7. However, the control device 50 may continue cleaning processing, for example, for a cleaning time determined in advance.

Next, as Step ST7, the control device 50 executes a drying processing step. As described above, the control device 50 temporarily stops the driving of the pump 24d, brings the cleaning liquid supply valve 22c into a closed state, and brings the air supply valve 23c into an open state to drive the air compressor 23a. In addition, the control device 50 controls the heater 24f based on the detection result of the temperature measurer 64 to heat the drying air A. Accordingly, the treatment tank 10, the common supply line 24b, and each nozzle portion 24a are quickly dried by the compressed and heated drying air A, and it is suppressed that the cleaning liquid CL remains.

As Step ST8, the control device 50 determines whether or not drying is completed. Whether or not drying is completed can be determined based on whether or not a difference between humidity inside the treatment tank 10 and humidity outside the treatment tank 10, which are input from the humidity measurer 62, is sufficiently small. In a case where it is determined that drying is not completed, the control device 50 continues the processing of Step ST7. On the other hand, in a case where it is determined that drying is completed, the control device 50 again executes the processing of Step ST1 and thereafter, and executes non-chromate treatment on the new metal part S.

In a case where it is determined that non-chromate treatment on all the metal parts S is completed in Step ST4, the control device 50 executes the cleaning processing step as Step ST9. Further, the control device 50 executes the drying processing step as Step ST10, and determines whether or not drying processing is completed as Step ST11. Since the processing of Step ST9 to Step ST11 is the same as the processing of Step ST6 to Step ST8, detailed description will be omitted. In a case where it is determined that drying is completed in Step ST11, the control device 50 ends this routine.

As described above, in the cleaning apparatus 200, the surface treatment apparatus 100, and the cleaning method according to the present embodiment, the cleaning liquid CL can be thoroughly supplied to the surface to be cleaned (inner surface) with a small amount of the cleaning liquid CL by spraying the cleaning liquid CL in a mist form to the treatment space 15 and filling the treatment space. Further, since water-repellent coating is performed on the treatment tank 10, it can be suppressed that the cleaning liquid CL sprayed in a mist form remains on the surface to be cleaned. As a result, it is not necessary to use the extra cleaning liquid CL, and the used amount of the cleaning liquid CL can be further reduced. In addition, the cleaning liquid CL can be quickly discharged from the treatment tank 10. Therefore, with the surface treatment apparatus 100 and a surface treatment method according to the present embodiment, it is possible to reduce the used amount and the waste liquid amount of the cleaning liquid CL used for cleaning away the treatment liquid PL, to sufficiently clean the surface to be cleaned, and to shorten the working time.

In addition, in the surface treatment apparatus 100 according to the present embodiment, since water-repellent coating is performed on the treatment tank 10, it is suppressed that the treatment liquid PL remains on the surface to be cleaned even in non-chromate treatment. As a result, it is not necessary to use the extra treatment liquid PL, and the used amount of the treatment liquid PL can be further reduced. In addition, the treatment liquid PL can be quickly discharged from the treatment tank 10.

In addition, the surface treatment apparatus 100 and the cleaning apparatus 200 further include a drying device that has the air compressor 23a and supplies the drying air A compressed by the air compressor 23a to the treatment space 15.

With this configuration, after the treatment tank 10 is cleaned with the cleaning liquid CL, the treatment tank 10 can be quickly dried by the drying device, and it can be suppressed that the cleaning liquid CL remains in the treatment tank 10. As a result, it is possible to quickly shift to processing after cleaning, and the working time can be shortened. The drying device may be omitted.

In addition, the drying device also has the heater 24f that heats the drying air A, which is compressed by the air compressor 23a and is supplied to the treatment space 15.

With this configuration, after the treatment tank 10 is cleaned with the cleaning liquid CL, the treatment tank 10 can be more quickly dried by the drying device. The heater 24f may be omitted.

In addition, the cleaning liquid supply device has the cleaning liquid supply line 22b and the common supply line 24b, through which the cleaning liquid CL is supplied to the nozzle portions 24a, and the drying device supplies the drying air A compressed by the air compressor 23a from the nozzle portions 24a to the treatment space 15 via the common supply line 24b.

With this configuration, it is possible for the drying device to supply the compressed drying air A also to the common supply line 24b and the nozzle portions 24a, and to suppress that the cleaning liquid CL remains in the common supply line 24b and the nozzle portions 24a. In addition, since the common supply line 24b and the nozzle portions 24a can be shared by the drying device and the cleaning liquid supply device, the apparatus configuration can be simplified.

The drying device and the cleaning liquid supply device may not share the common supply line 24b and the nozzle portions 24a. That is, an air supply dedicated line different from the common supply line 24b and an air spraying nozzle different from the nozzle portions 24a may be provided, and the drying air A compressed by the air compressor 23a may be supplied from the air supply dedicated line and the air spraying nozzle to the treatment tank 10. In this case, the heater 24f may be provided in the air supply dedicated line. In addition, similarly, in order to supply the treatment liquid PL to the treatment tank 10, a treatment liquid dedicated line and a treatment liquid spraying nozzle may be separately provided.

In addition, the nozzle portions 24a are one-fluid spray nozzles.

With this configuration, facility introduction costs, running costs, and maintenance costs can be reduced compared with a configuration where the cleaning liquid CL in a mist form is sprayed using an inert gas. A configuration where the cleaning liquid CL in a mist form is sprayed using an inert gas may be adopted.

In addition, the surface treatment apparatus 100 and the cleaning apparatus 200 further include the humidity measurer 62 that measures humidity inside the treatment tank 10 and outside the treatment tank.

With this configuration, when the cleaning liquid CL is discharged from the treatment tank 10, whether or not the discharging of the cleaning liquid CL is completed can be accurately determined by comparing humidity inside the treatment space 15 with humidity outside the treatment space. The humidity measurer 62 may be omitted.

In addition, the surface treatment apparatus 100 and the cleaning apparatus 200 further include the collecting line 32, in which the cleaning liquid CL collected from the treatment space 15 flows, and the electric conductivity meter 65 which measures a degree of contamination of the cleaning liquid CL flowing in the collecting line 32.

With this configuration, when discharging the cleaning liquid CL from the treatment tank 10, a degree of contamination of the cleaning liquid CL flowing in the collecting line 32 is measured by the electric conductivity meter 65, and whether or not cleaning is completed can be accurately determined by comparing the measured degree of contamination with a predetermined reference value. The electric conductivity meter 65 may be omitted.

In addition, the surface treatment apparatus 100 and the cleaning apparatus 200 further include the suppression device 40 that suppresses the leakage of the treatment liquid PL and the cleaning liquid CL from the opening 10a provided in the upper portion of the treatment tank 10.

With this configuration, the loss of the treatment liquid PL and the cleaning liquid CL can be suppressed. The suppression device 40 may be omitted.

In addition, the suppression device 40 is an air curtain device that seals the opening 10a with an air flow.

With this configuration, the suppression device 40 having a lighter weight and a simpler configuration can be configured compared with a case where a mechanism that opens and closes the opening 10a of the treatment tank 10 is provided. In addition, the suppression device 40 can be easily configured only by attaching the air curtain device to the existing treatment tank 10. The suppression device 40 is not limited to the air curtain device. For example, as the suppression device 40, a lid-shaped member that can open and close the opening 10a of the treatment tank 10 and a drive mechanism that moves the lid-shaped member may be provided.

In addition, the temperature adjusting device 24e that adjusts the temperature of the cleaning liquid CL supplied to the nozzle portions 24a is further included.

With this configuration, the temperature of the cleaning liquid CL can be finely adjusted and the treatment liquid PL from the treatment tank 10 can be cleaned away more adequately. The temperature adjusting device 24e may be omitted.

In addition, the mist concentration measurer 61 that measures a mist concentration inside the treatment space 15 is further included.

With this configuration, the mist concentration of the cleaning liquid CL with which the treatment space 15 is filled can be managed and appropriately adjusted. The mist concentration measurer 61 may be omitted.

In addition, the average droplet diameter of the mist of the cleaning liquid CL is preferably 70 [μm] or less and more preferably 20 [μm] or more and 40 [μm] or less.

With this configuration, the average droplet diameter of the mist can be made sufficiently small, and the mist can slowly drift in the treatment space 15. As a result, it is possible to sufficiently supply the cleaning liquid CL to the surface to be cleaned.

In addition, the mist concentration of the cleaning liquid CL in the treatment space 15 is preferably 100 [mL] or more and 5,000 [mL] or less per 1 [m³] of the treatment space 15.

With this configuration, the cleaning liquid can be sufficiently supplied to the surface to be cleaned while suppressing an increase in the used amount of the cleaning liquid CL supplied to the treatment space 15.

In addition, the amount of the cleaning liquid CL supplied from each nozzle portion 24a to the treatment space 15 is preferably 1.5 [L/min] or less, and more preferably 1.0 [L/min] or more and 1.5 [L/min] or less per 1 [m³] of the treatment space 15.

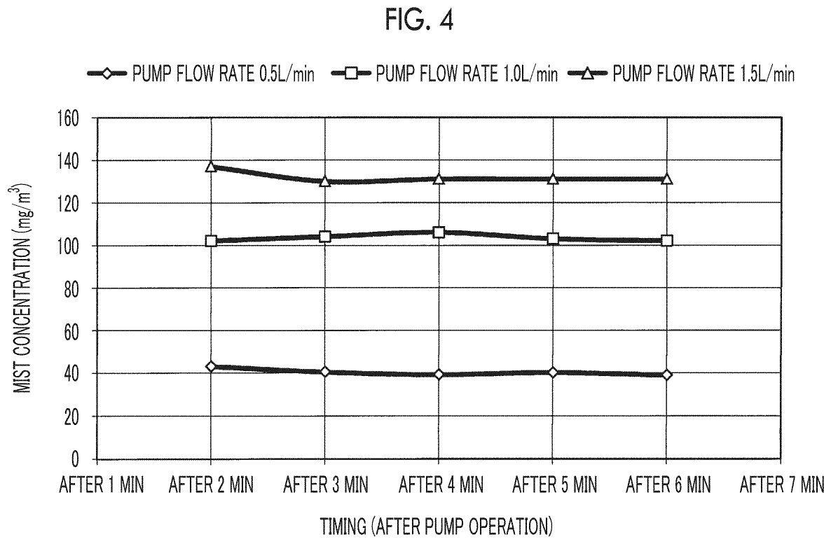

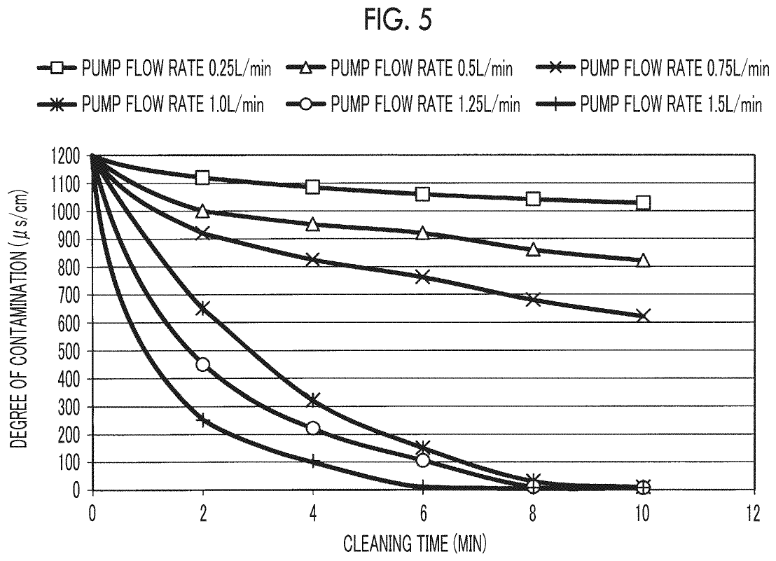

With this configuration, the cleaning liquid CL can be sufficiently supplied to the surface to be cleaned while suppressing an increase in the used amount of the cleaning liquid CL supplied to the treatment space 15. FIG. 4 is an explanatory graph showing a relationship between a cleaning time and the mist concentration in the treatment space in a case where pump flow rate is changed in the surface treatment apparatus according to the present embodiment. FIG. 5 is an explanatory graph showing a relationship between a cleaning time and a degree of contamination in a case where pump flow rate is changed in the surface treatment apparatus according to the present embodiment. The degree of contamination in FIG. 5 indicates conductivity in the treatment tank 10. It can be considered that the higher the conductivity, the more the cleaning liquid CL remains. In addition, the pump flow rate in FIGS. 4 and 5 is the discharge flow rate of the cleaning liquid CL in the pump 24d, and herein, the pump flow rate matches the flow rate of the cleaning liquid supplied from the nozzle portions 24a per 1 [m³] of the treatment space 15.

As shown in FIG. 5, it can be seen that a degree of contamination of the treatment tank 10 decreases particularly quickly at the pump flow rate of 1.0 [L/min] or more. On the other hand, the degree of contamination does not differ that much in terms of a degree of decrease in a range where the pump flow rate is 1.0 [L/min] or more and 1.5 [L/min] or less. Therefore, by setting the pump flow rate to 1.0 [L/min] or more and 1.5 [L/min] or less, it is possible to achieve both a quick decrease in a degree of contamination and the suppression of an increase in the used amount of the cleaning liquid CL. In addition, as shown in FIG. 4, the mist concentration in the treatment space 15 increases more in a case where the pump flow rate is 1.0 [L/min] than in a case where the pump flow rate is 0.5 [L/min].

Although the treatment liquid PL is sprayed in a mist form from the nozzle portions 24a and is supplied to the treatment space 15 in non-chromate treatment in the present embodiment, the treatment liquid PL may be supplied through any method insofar as the treatment liquid PL can be sufficiently adhered to the metal part S.

In addition, in the present embodiment, cleaning processing and drying processing are executed after the carry-out step (Step ST3) in FIG. 3. However, after non-chromate treatment is performed on the metal part S, cleaning processing and drying processing may be executed before the metal part S is carried out from the treatment tank 10. Accordingly, cleaning processing and drying processing can be performed not only in the treatment tank 10 but also on the metal part S.

In addition, in the present embodiment, the surface treatment apparatus 100 includes the cleaning apparatus 200 (a configuration excluding the treatment liquid supply system 21 in FIG. 1) according to the embodiment. However, the cleaning apparatus 200 may be a device different from the surface treatment apparatus 100. That is, the metal part S having a surface, to which the treatment liquid PL is supplied, is disposed in the treatment space 15 in another apparatus, and the cleaning apparatus 200 may be configured as an apparatus for cleaning away the treatment liquid PL adhered to the metal part S.

In addition, in the present embodiment, an example of cleaning away the treatment liquid PL using the cleaning apparatus 200 in surface treatment, in which an object to be treated is the metal part S and the treatment liquid PL is supplied to the surface of the metal part S, is described. However, the object to be treated is not limited to the metal part S, and the treatment liquid PL is not limited to the non-chromate treatment liquid. The cleaning apparatus 200 may be any apparatus insofar as the apparatus cleans away a treatment liquid for performing some surface treatment on surfaces of some objects to be treated.

### REFERENCE SIGNS LIST

10 treatment tank
10a opening
11 main body portion
11a inner side surface
11b bottom surface
12 collection portion
12a discharge port
15 treatment space
20 supply unit
21 treatment liquid supply system
21a treatment liquid storage portion
21b treatment liquid supply line
21c treatment liquid supply valve
22 cleaning liquid supply system
22a cleaning liquid storage portion
22b cleaning liquid supply line
22c cleaning liquid supply valve
23 air supply system
23a air compressor
23b air supply line
23c air supply valve
24 common supply system
24a nozzle portion
241a spray port
24b common supply line
24c common supply valve
24d pump
24e temperature adjusting device
24f heater
30 collecting unit
31 waste liquid pit
32 collecting line
33 collecting valve
35 circulation line
36 circulation valve
40 suppression device
41 air jetting unit
41a jetting port
42 air suction unit
42a suction port
43 mist collector
44 blower
50 control device
61 mist concentration measurer
62 humidity measurer
63, 64 temperature measurer
65 electric conductivity meter
100 surface treatment apparatus
A drying air
CL cleaning liquid
PL non-chromate treatment liquid (treatment liquid)
S metal part

1. A cleaning apparatus comprising:
a treatment tank that defines a treatment space with an inner surface thereof, the inner surface being subjected to water-repellent coating; and
a cleaning liquid supply device that has a cleaning liquid spraying nozzle spraying, into the treatment space, a cleaning liquid for cleaning away at least one of a treatment liquid for surface treatment, which is adhered to a surface of an object to be treated, and a treatment liquid adhered to the inner surface, in a mist form.

2. The cleaning apparatus according to claim 1, further comprising:
a drying device that has an air compressor and supplies drying air compressed by the air compressor to the treatment space.

3. The cleaning apparatus according to claim 2,
wherein the drying device has a heater that heats the drying air which is compressed by the air compressor and is supplied to the treatment space.

4. The cleaning apparatus according to claim 2,
wherein the cleaning liquid supply device has a supply line through which the cleaning liquid is supplied to the cleaning liquid spraying nozzle, and
the drying device supplies the drying air compressed by the air compressor from the cleaning liquid spraying nozzle to the treatment space via the supply line.

5. The cleaning apparatus according to claim 1,
wherein the cleaning liquid spraying nozzle is a one-fluid spray nozzle.

6. The cleaning apparatus according to claim 1, further comprising:
a humidity measurer that measures humidity inside the treatment tank and humidity outside the treatment tank.

7. The cleaning apparatus according to claim 1, further comprising:
a collecting line in which the cleaning liquid collected from the treatment space flows; and
an electric conductivity meter that measures a degree of contamination of the cleaning liquid flowing in the collecting line.

8. The cleaning apparatus according to claim 1, further comprising:
a suppression device that suppresses leakage of the cleaning liquid from an opening provided in an upper portion of the treatment tank.

9. The cleaning apparatus according to claim 8,
wherein the suppression device is an air curtain device that seals the opening with an air flow.

10. The cleaning apparatus according to claim 1, further comprising:
a temperature adjusting device that adjusts a temperature of the cleaning liquid supplied to the cleaning liquid spraying nozzle.

11. The cleaning apparatus according to claim 1, further comprising:
a mist concentration measurer that measures a mist concentration inside the treatment space.

12. The cleaning apparatus according to claim 1,
wherein an average droplet diameter of mist of the cleaning liquid is 70 [μm] or less.

13. The cleaning apparatus according to claim 1,
wherein a mist concentration of the cleaning liquid in the treatment space is 100 [mL] or more and 5,000 [mL] or less per 1 [m³] of the treatment space.

14. The cleaning apparatus according to claim 1,
wherein an amount of the cleaning liquid supplied from the cleaning liquid spraying nozzle to the treatment space is 1.5 [L/min] or less per 1 [m³] of the treatment space.

15. A surface treatment apparatus comprising:
the cleaning apparatus according to claim 1; and
a treatment liquid supply device that supplies a treatment liquid for performing surface treatment on an object to be treated disposed in the treatment space of the treatment tank.

16. A cleaning method comprising:
spraying, to a treatment space of a treatment tank that defines the treatment space with an inner surface thereof, the inner surface being subjected to water-repellent coating, a cleaning liquid for cleaning away at least one of a treatment liquid for surface treatment, which is adhered to a surface of an object to be treated, and a treatment liquid, which is adhered to the inner surface, in a mist form.

17. The cleaning method according to claim 16, further comprising:
supplying drying air compressed by an air compressor to the treatment space after the spraying.
